(19) United States
(12) Patent Application Publication
(10) Pub. No.: US 2009/0131581 A1
(43) Pub. Date: May 21, 2009

(54) Aqueous, stain-resistant coating compositions

(76) Inventors: Amy S. Wylie, Aliquippa, PA (US); Carol L. Kinney, Eighty Four, PA (US); Richard R. Roesler, Wexford, PA (US); Ronald G. Eritano, Coraopolis, PA (US)

Correspondence Address: BAYER MATERIAL SCIENCE LLC, 100 BAYER ROAD, PITTSBURGH, PA, 15205, US

(21) Appl. No.: 11/985,905

(22) Filed: Nov. 19, 2007

(51) Int. Cl. C08K 3/20; C08G 18/28; C08G 75/04

(52) U.S. Cl. 524/591

(57) ABSTRACT

The present invention is directed to an aqueous coating composition comprising the reaction product of a hydrophobic, fluorine-functional polyisocyanate and an aqueous hydroxy-functional polyisocyanate.

The present invention is also directed to a process for the production of this aqueous coating composition.

### BACKGROUND OF THE INVENTION

1. Field of the Invention

The present invention is directed to an aqueous coating composition comprising the reaction product of a hydrophobic, fluorine-functional polyisocyanate and an aqueous hydroxy-functional polyisocyanate.

The present invention is also directed to a process for the production of this aqueous coating composition.

2. Description of the Prior Art

Polyurethane coating compositions containing a polyisocyanate component, in either blocked or unblocked form and an isocyanate-reactive component, generally a high molecular weight polyol, are well known.

Although coatings prepared from these compositions possess many valuable properties, one property, in particular, which needs to be improved is the surface quality. It can be difficult to formulate coating compositions to obtain a coating having a smooth surface as opposed to one containing surface defects such as craters, etc.

It is believed that these difficulties are related to the high surface tension of the two-component coating compositions. Another problem caused by the high surface tension is the difficulty in cleaning the coatings. Regardless of their potential application area, there is a high likelihood that the coatings will be subjected to stains, graffiti, etc.

The incorporation of either fluorine or siloxane groups into polyisocyanates via allophanate groups in order to reduce the surface tension of the polyisocyanates and the surface energy of the resulting polyurethane coatings is disclosed in U.S. Pat. Nos. 5,541,281; 5,574,122; 5,576,411; 5,646,227; 5,691,439; and 5,747,629. A disadvantage of the polyisocyanates disclosed in these patents is that they are prepared by reacting an excess of monomeric diisocyanates with the compounds containing either fluorine or siloxane groups. After the reaction is terminated, the unreacted monomeric diisocyanates must be removed by an expensive thin film distillation process. In addition, it is important to avoid the use of any unnecessary apparatus, such as distillation apparatus, when preparing the low surface energy polyisocyanates because fluorine and the siloxane groups can contaminate the production apparatus requiring extensive cleaning before the apparatus can be used to prepare other products.

U.S. Published Patent Application No. 2006/0223970 describes low surface energy polyisocyanates prepared from polyisocyanate adducts which avoid the costly distillation process. However, the coating compositions described therein are non-aqueous compositions and therefore, are disfavored from an environmental perspective.

U.S. Pat. No. 5,194,487 describes a conventional aqueous, two-component polyurethane dispersion. As disclosed therein, the polyisocyanate must be modified to impart hydrophilicity prior to combination with the aqueous, hydroxyl functional polyurethane.

Accordingly, it is an object of the present invention to provide coating compositions which have reduced surface tension and, thus, are suitable for the production of coatings which have lower surface energies, improved surfaces and improved cleanability and which also possess the other valuable properties of the known polyurethane coatings. It is an additional object of the present invention to provide aqueous coating compositions that exhibit such properties.

Surprisingly, these objectives may be achieved with the polyisocyanate mixtures according to the present invention containing allophanate groups and fluorine which are described hereinafter. These polyisocyanate mixtures are prepared from polyisocyanate adducts instead of monomeric diisocyanates. Such polyisocyanate mixtures may be mixed with an aqueous, hydroxy functional polyurethane despite the typically hydrophobic nature of such polyisocyanate mixtures.

### SUMMARY OF THE INVENTION

The present invention is directed to an aqueous coating composition comprising the reaction product of

A) a hydrophobic polyisocyanate mixture,
i) having an NCO content of 5 to 35% by weight and a monomeric diisocyanate content of less than 3% by weight, and prepared from a polyisocyanate adduct,
ii) containing allophanate groups in an amount such that there are more equivalents of allophanate groups than urethane groups and
iii) containing fluorine (calculated as F, AW 19) in an amount of 0.001 to 50% by weight,
wherein the preceding percentages are based on the solids content of the polyisocyanate mixture and wherein fluorine is incorporated by reacting an isocyanate group with a compound containing two or more carbon atoms, one or more hydroxyl groups and one or more fluorine atoms, and

B) an aqueous, hydroxy-functional polyurethane dispersion.

The present invention is also directed to a process for the production of an aqueous coating composition comprising
1) preparing a hydrophobic polyisocyanate mixture
i) having an NCO content of 5 to 35% by weight and a monomeric diisocyanate content of less than 3% by weight, and prepared from a polyisocyanate adduct,
ii) containing allophanate groups in an amount such that there are more equivalents of allophanate groups than urethane groups and
iii) containing fluorine (calculated as F, AW 19) in an amount of 0.001 to 50% by weight,
   wherein the preceding percentages are based on the solids content of the polyisocyanate mixture, by
a) reacting a portion of the isocyanate groups of a polyisocyanate adduct with 0.01 to 500 millimoles, per mole of polyisocyanate adduct, of a compound containing two or more carbon atoms, one or more hydroxyl groups and one or more fluorine atoms to form urethane groups,
b) adding an allophanatization catalyst prior to, during or after step a),
c) converting a sufficient amount of the urethane groups formed in step a) to allophanate groups to satisfy the requirements of ii) and
d) terminating the allophanatization reaction at the desired NCO content by adding a catalyst poison and/or by thermally deactivating the catalyst and recovering the polyisocyanate mixture without removing monomeric diisocyanates,
2) before, during or after step 1), preparing an aqueous, hydroxy-functional polyurethane dispersion, and
3) combining the hydrophobic polyisocyanate mixture with the aqueous, hydroxy-functional polyurethane dispersion.

### DETAILED DESCRIPTION OF THE INVENTION

In accordance with the present invention the term “(cyclo)aliphatically bound isocyanate groups” means aliphatically and/or cycloaliphatically bound isocyanate groups.

In accordance with the present invention, the polyisocyanate mixtures are prepared from polyisocyanate adducts which are prepared from monomeric polyisocyanates and contain isocyanurate, uretdione, biuret, urethane, allophanate, iminooxadiazine dione, carbodiimide, acylurea and/or oxadiazinetrione groups. The polyisocyanate adducts, which preferably have an NCO content of 5 to 30% by weight, include:

1) Isocyanurate group-containing polyisocyanates which may be prepared as set forth in DE 2,616,416, EP-OS 3,765, EP-OS 10,589, EP-OS 47,452, U.S. Pat. Nos. 4,288,586 and 4,324,879. The isocyanato-isocyanurates generally have an average NCO functionality of 3 to 4.5 and an NCO content of 5 to 30%, preferably 10 to 25% and most preferably 15 to 25% by weight.

2) Uretdione diisocyanates which may be prepared by oligomerizing a portion of the isocyanate groups of a diisocyanate in the presence of a suitable catalyst, e.g., a trialkyl phosphine catalyst, and which may be used in admixture with other aliphatic and/or cycloaliphatic polyisocyanates, particularly the isocyanurate group-containing polyisocyanates set forth under (1) above.

3) Biuret group-containing polyisocyanates which may be prepared according to the processes disclosed in U.S. Pat. Nos. 3,124,605; 3,358,010; 3,644,490; 3,862,973; 3,906,126; 3,903,127; 4,051,165; 4,147,714; or 4,220,749 by using co-reactants such as water, tertiary alcohols, primary and secondary monoamines, and primary and/or secondary diamines. These polyisocyanates preferably have an NCO content of 18 to 22% by weight.

4) Iminooxadiazine dione and optionally isocyanurate group-containing polyisocyanates which may be prepared in the presence of special fluorine-containing catalysts as described in DE-A 19611849. These polyisocyanates generally have an average NCO functionality of 3 to 3.5 and an NCO content of 5 to 30%, preferably 10 to 25% and most preferably 15 to 25% by weight.

5) Carbodiimide group-containing polyisocyanates which may be prepared by oligomerizing di- or polyisocyanates in the presence of known carbodiimidization catalysts as described in DE 1,092,007, U.S. Pat. No. 3,152,162, DE 2,504,400, DE 2,537,685 and DE 2,552,350.

6) Polyisocyanates containing oxadiazinetrione groups and containing the reaction product of two moles of a diisocyanate and one mole of carbon dioxide.

Preferred polyisocyanate adducts are the polyisocyanates containing isocyanurate, uretdione, biuret, and/or iminooxadiazine dione groups, especially polyisocyanate containing isocyanurate groups and optionally uretdione or iminooxadiazine dione groups.

Suitable monomeric diisocyanates for preparing the polyisocyanate adducts include those represented by the formula

R(NCO)₂

in which R represents an organic group obtained by removing the isocyanate groups from an organic diisocyanate having a molecular weight of about 140 to 400. Preferred diisocyanates are those in which R represents a divalent aliphatic hydrocarbon group having 4 to 40, preferably 4 to 18 carbon atoms, a divalent cycloaliphatic hydrocarbon group having 5 to 15 carbon atoms, a divalent araliphatic hydrocarbon group having 7 to 15 carbon atoms or a divalent aromatic hydrocarbon group having 6 to 15 carbon atoms.

Examples of the suitable organic diisocyanates include 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3- and -1,4-diisocyanate, 1-isocyanato-2-isocyanatomethyl cyclopentane, 1-isocyanato-3-isocyanatomethyl-3,5,5-trimethyl-cyclohexane (isophorone diisocyanate or IPDI), bis-(4-iso-cyanatocyclohexyl)-methane, 2,4′-dicyclohexyl-methane diisocyanate, 1,3- and 1,4-bis-(isocyanatomethyl)-cyclohexane, bis-(4-isocyanato-3-methyl-cyclohexyl)-methane, α,α,α′,α′-tetramethyl-1,3- and/or -1,4-xylylene diisocyanate, 1-isocyanato-1-methyl-4(3)-isocyanatomethyl cyclohexane, 2,4- and/or 2,6-hexahydrotoluylene diisocyanate, 1,3- and/or 1,4-phenylene diisocyanate, 2,4- and/or 2,6-toluylene diisocyanate, 2,4- and/or 4,4′-diphenyl-methane diisocyanate, 1,5-diisocyanato naphthalene and mixtures thereof.

Polyisocyanates containing 3 or more isocyanate groups such as 4-isocyanantomethyl-1,8-octamethylene diisocyanate and aromatic polyisocyanates such as 4,4′,4″-triphenylmethane triisocyanate and polyphenyl polymethylene polyisocyanates obtained by phosgenating aniline/formaldehyde condensates may also be used.

Preferred organic diisocyanates include 1,6-hexamethylene diisocyanate, 1-isocyanato-3-isocyanatomethyl-3,5,5-trimethyl-cyclohexane (isophorone diisocyanate or IPDI), bis-(4-isocyanato-cyclohexyl)-methane, α,α,α′,α′-tetramethyl-1,3- and/or -1,4-xylylene diisocyanate, 2,4- and/or 2,6-toluylene diisocyanate, and 2,4- and/or 4,4′-diphenylmethane diisocyanate.

In accordance with the present invention, urethane groups and preferably allophanate groups are incorporated into the polyisocyanate mixtures by the use of compounds containing two or more carbon atoms, one or more hydroxyl groups (preferably one or two hydroxyl groups, more preferably one) and one or more fluorine atoms (preferably in the form of fluoroalkyl groups such as —CF₂—). Examples of these compounds include aliphatic, cycloaliphatic, araliphatic or aromatic hydroxyl group-containing compounds, which contain two or more carbon atoms and also contain fluorine atoms, preferably fluoroalkyl groups. The compounds may be linear, branched or cyclic and have a molecular weight (number average molecular weight as determined by gel permeation chromatography using polystyrene as standard) of up to 50,000, preferably up to 10,000, more preferably up to 6000 and most preferably up to 2000. These compounds generally have OH numbers of greater than 5, preferably greater than 25 and more preferably greater than 35. The hydroxyl group-containing compounds may optionally contain other hetero atoms in the form of, e.g., ether groups, ester groups, carbonate groups, acrylic groups, etc.

Thus, it is possible in accordance with the present invention to use the known polyols from polyurethane chemistry, provided that they contain fluorine, e.g. by using fluorine-containing alcohols, acids, unsaturated monomers, etc. in the preparation of these polyols. Examples of these polyols, which may be prepared from fluorine-containing precursors and used in accordance with the present invention, are disclosed in U.S. Pat. No. 4,701,480, the disclosure of which is herein incorporated by reference. Additional examples of suitable fluorine-containing compounds are disclosed in U.S. Pat. Nos. 5,294,662 and 5,254,660, the disclosures of which are herein incorporated by reference.

Preferred for use according to the invention are compounds containing one or more hydroxyl groups, preferably one or two hydroxyl groups and more preferably one hydroxyl group; one or more fluoroalkyl groups; optionally one or more methylene groups; and optionally other hetero atoms such as ether groups. These compounds preferably have a molecular weight of less than 2000 or a hydroxyl number of greater than 28.

To prepare the polyisocyanates mixtures according to the invention the minimum ratio of fluorine-containing compounds to polyisocyanate adduct is about 0.01 millimoles, preferably about 0.1 millimoles and more preferably about 1 millimole of fluorine-containing compounds for each mole of polyisocyanates adduct. The maximum amount of fluorine-containing compounds to polyisocyanate adduct is about 500 millimoles, preferably about 100 millimoles and more preferably about 20 millimoles of fluorine-containing compounds for each mole of polyisocyanate adduct. The amount of fluorine is selected such that the resulting polyisocyanate mixture contains a minimum of 0.001% by weight, preferably 0.01% by weight and more preferably 0.1% by weight, of fluorine (calculated as F, AW 19), based on solids, and a maximum of 50% by weight, preferably 10% by weight, more preferably 7% by weight and most preferably 3% by weight of fluorine, based on solids.

Suitable methods for preparing the polyisocyanate mixtures containing allophanate groups are known and described in U.S. Pat. Nos. 3,769,318, 4,160,080 and 4,177,342 and 4,738,991, the disclosures of which are herein incorporated by reference. The allophanatization reaction may be conducted at a temperature of 50 to 250° C., preferably 60 to 150° C. and more preferably 70 to 120° C. The reaction may be terminated by reducing the reaction temperature, by removing the catalyst, e.g., by applying a vacuum, or by the addition of a catalyst poison. After the reaction is terminated, there is no need to remove unreacted monomeric diisocyanates, e.g., by thin film evaporation, because polyisocyanate adducts having low monomeric diisocyanate contents are used as the starting material.

The allophanatization reaction may be carried out in the absence or in the presence of solvents which are inert to isocyanate groups, preferably in the absence of solvents, especially when liquid starting materials are used. Depending on the area of application of the products according to the invention, low to medium-boiling solvents or high-boiling solvents can be used. Suitable solvents include esters such as ethyl acetate or butyl acetate; ketones such as acetone or butanone; aromatic compounds such as toluene or xylene; halogenated hydrocarbons such as methylene chloride and trichloroethylene; ethers such as diisopropylether; and alkanes such as cyclohexane, petroleum ether or ligroin.

The process according to the invention may take place either batchwise or continuously, for example, as described below. The starting polyisocyanate adduct is introduced with the exclusion of moisture and optionally with an inert gas into a suitable stirred vessel or tube and optionally mixed with a solvent which is inert to isocyanate groups such as toluene, butyl acetate, diisopropylether or cyclohexane. The previously described compounds containing fluorine and hydroxyl groups may be introduced into the reaction vessel in accordance with several embodiments. They may be prereacted with the starting polyisocyanate adduct to form urethane and prior to introducing the polyisocyanate adducts into the reaction vessel; they may be mixed with the polyisocyanate adducts and introduced into the reaction vessel; they may be separately added to the reaction vessel either before or after, preferably after, the polyisocyanate adducts are added; or the catalyst may be dissolved in these compounds prior to introducing the solution into the reaction vessel.

The progress of the reaction is followed by determining the NCO content by a suitable method such as titration, refractive index or IR analysis. Thus, the reaction may be terminated at the desired degree of allophanatization. The termination of the allophanatization reaction can take place, for example, after the NCO content has fallen by 5 to 80% by weight, preferably 10 to 60% by weight and more preferably 20 to 50% by weight, based on the initial isocyanate group content of the polyisocyanate adduct starting material.

The polyisocyanate mixtures obtained in accordance with the present invention have an average functionality of about 2 to 7, preferably 2 to 4; an NCO content of 10 to 35% by weight, preferably 10 to 30% by weight and more preferably 15 to 30% by weight; and a monomeric diisocyanate content of less than 3% by weight, preferably less than 2% by weight and more preferably less than 1% by weight. The polyisocyanate mixtures have an allophanate group content (calculated as N₂, C₂, H, O₃, MW 101) of preferably at least 0.001% by weight, more preferably at least 0.01% by weight and most preferably at least 0.5% by weight. The upper limit for the allophanate group content is preferably 20%, preferably 10% by weight and most preferably 5% by weight. The preceding percentages are based on the solids content of the polyisocyanate mixtures.

The products according to the present invention are polyiso-cyanate mixtures containing allophanate groups and fluorine. The products may also contain residual urethane groups which are not converted to allophanate groups depending upon the temperature maintained during the reaction and the degree of isocyanate group consumption. While it is preferred to convert at least 50%, more preferably at least 70% and most preferably at least 90% of the urethane groups formed from the fluorine-containing hydroxyl compounds to allophanate groups, it is not necessary provided that the number of equivalents of allophanate groups exceeds the number of equivalents of urethane groups. Preferably, the polyisocyanate mixture contains sufficient allophanate groups to ensure that the polyisocyanate mixture remains stable and homogeneous in storage for 1 month at 25° C., more preferably for 3 months at 25° C. If the polyisocyanate mixture contains an insufficient number of allophanate groups, the mixture may be cloudy and a gradual settling of insoluble constituents may take place during storage.

The products according to the invention are valuable starting materials for the production of polyisocyanate polyaddition products by reaction with compounds containing at least two isocyanate reactive groups. The products according to the invention may also be moisture-cured to form coatings. Preferred products are one or two-component coating compositions, more preferably polyurethane coating compositions. When the polyisocyanates are unblocked, two-component compositions are obtained. To the contrary when the polyisocyanates are blocked, one-component compositions are obtained.

Prior to their use in coating compositions, the polyisocyanate mixtures according to the present invention may be blended with other known polyisocyanates, e.g., polyisocyanate adducts containing biuret, isocyanurate, allophanate, urethane, urea, carbodiimide, and/or uretdione groups. The amount of the polyisocyanates mixtures according to the present invention that must be blended with these other polyisocyanates is dependent upon the fluorine content of the polyisocyanate mixtures according to the invention, the intended application of the resulting coating compositions and the amount of low surface energy properties which are desired for this application.

To obtain low surface energy properties the resulting poly-isocyanate blends should contain a minimum of 0.001% by weight, preferably 0.01% by weight and more preferably 0.1% by weight, of fluorine (AW 19), based on solids, and a maximum of 10% by weight, preferably 7% by weight and more preferably 3% by weight of fluorine (AW 19), based on solids. While fluorine contents of greater that 10% by weight are also suitable for providing low surface energy coatings, there are no further improvements to be obtained by using higher quantities. By knowing the fluorine content of the polyisocyanate mixtures according to the invention and the desired fluorine content of the resulting polyisocyanate blends, the relative amounts of the polyisocyanate mixtures and the other polyisocyanates may be readily determined.

In accordance with the present invention, any of the polyisocyanate mixtures according to the invention can be blended with other polyiso-cyanates, provided that the resulting blends have the minimum fluorine content required for the polyisocyanate mixtures of the present invention. However, the polyisocyanate mixtures to be blended preferably have a minimum fluorine content of 5% by weight, more preferably 10% by weight, and preferably have a maximum fluorine content of 50% by weight, more preferably 40% by weight and most preferably 30% by weight. These so-called “concentrates” may then be blended with other polyisocyanates to form polyisocyanate blends that may be used to prepare coatings having low surface energy characteristics.

Several advantages are obtained by preparing concentrates with high fluorine contents and subsequently blending them with non-fluorine-containing polyisocyanates. Initially, it is possible to convert many products to low surface energy polyisocyanates while only producing one concentrate. By forming such low surface energy polyisocyanates by blending commercially available polyisocyanates with concentrates, it is not necessary to separately prepare each of the products in both a fluorine-containing and a non-fluorine-containing form. One possible disadvantage of the highest fluorine contents is that all of the isocyanate groups of a small portion of the starting polyisocyanate adducts may be reacted. These molecules that do not contain isocyanate groups cannot react into the resulting coating and, thus, may adversely affect the properties of the final coating.

The hydroxy functional polyurethanes used in conjunction with the water dispersible polyisocyanates and polyol additives in accordance with the present invention have an average hydroxy functionality of at least 1.8, preferably 1.8 to 8, more preferably 2 to 6 and most preferably 2.5 to 6; a total content of urethane and urea groups of 9 to 20% by weight, preferably about 10 to 17% by weight; and an average hydroxy equivalent weight (which may be calculated by an end group analysis) of about 100 to 5000, preferably 500 to 4000 and more preferably 1000 to 3000.

The hydroxy functional polyurethanes are based on the reaction product of organic polyisocyanates with high molecular weight polyols, optionally low molecular weight, isocyanate-reactive compounds, and at least one of isocyanate-reactive compounds containing anionic or potential anionic groups and isocyanate-reactive compounds containing nonionic hydrophilic groups. The reactants and their amounts are selected to ensure that the resulting polyurethane is hydroxy functional.

Suitable polyisocyanates for preparing the hydroxy functional polyurethane include any organic polyisocyanate, preferably monomeric diisocyanates. Especially preferred are polyisocyanates, especially diisocyanates, having aliphatically- and/or cycloaliphatically-bound isocyanate groups, although polyisocyanates having aromatically-bound isocyanate groups are not excluded and may be used.

Examples of suitable polyisocyanates which may be used include ethylene diisocyanate, 1,4-tetramethylene diisocyanate, 1,6-hexamethylene diisocyanate, 2,4,4-trimethyl-1,6-hexamethylene diisocyanate, 1,12-dodecane diisocyanate, cyclobutane-1,3-diisocyanate, cyclohexane-1,3- and/or -1,4-diisocyanate, 1-isocyanato-2-isocyanatomethyl cyclopentane, 1-isocyanato-3,3,5-trimethyl-5-isocyanatomethyl cyclohexane (isophorone diisocyanate or IPDI), 2,4- and/or 2,6-hexahydrotoluylene diisocyanate, 2,4′- and/or 4,4′-dicyclohexylmethane diisocyanate, α,α,α′,α′-tetramethyl-1,3- and/or -1,4-xylylene diisocyanate, 1,3- and 1,4-xylylene diisocyanate, 1-isocyanato-1-methyl-4(3)-isocyanatomethyl-cyclohexane, 1,3- and 1,4-phenylene diisocyanate, 2,4- and/or 2,6-toluylene diisocyanate, diphenyl methane-2,4′- and/or -4,4′-diisocyanate, naphthalene-1,5-diisocyanate, triphenyl methane-4,4′,4″-triisocyanate, polyphenyl polymethylene polyisocyanates of the type obtained by condensing aniline with formaldehyde followed by phosgenation, and mixtures of the above-mentioned polyisocyanates.

Suitable high molecular weight polyols for preparing the hydroxy functional polyurethane include those which are known from polyurethane chemistry and have molecular weights (Mₙ) of 400 to 6,000, preferably 400 to 3,000. Examples of the high molecular weight compounds include:

1) polyhydroxy polyesters which are obtained from polyhydric, preferably dihydric alcohols to which trihydric alcohols may be added and polybasic, preferably dibasic carboxylic acids. Instead of these polycarboxylic acids, the corresponding carboxylic acid anhydrides or polycarboxylic acid esters of lower alcohols or mixtures thereof may be used for preparing the polyesters. The polycarboxylic acids may be aliphatic, cyclocycloaliphatic, aromatic and/or heterocyclic and they may be unsaturated and/or substituted, e.g. by halogen atoms. Examples of these acids include succinic acid, adipic acid, suberic acid, azelaic acid, sebacic acid, phthalic acid, isophthalic acid, trimellitic acid, phthalic acid anhydride, tetrahydropthalic acid anhydride, hexahydrophthalic acid anhydride, tetrachlorophthalic acid anhydride, endomethylene tetrahydrophthalic acid anhydride, glutaric acid anhydride, maleic acid, maleic acid anhydride, fumaric acid, dimeric and trimeric fatty acids such as oleic acid (which may be mixed with monomeric fatty acids), dimethyl terephthalate and bis-glycol terephthalate. Suitable polyhydric alcohols include ethylene glycol, 1,2- and 1,3-propylene glycol, 1,3- and 1,4-butanediol, 1,6-hexanediol, 1,8-octanediol, neopentyl glycol, diethylene glycol, 2-methyl-1,3-propylene glycol, 2,2-dimethyl-1,3-propylene glycol, the various isomeric bis-hydroxymethyl cyclohexanes, 2,2,4-trimethyl-1,3-pentanediol, glycerine and trimethylol propane.

2) Polylactones generally known from polyurethane chemistry, e.g., polymers of ε-caprolactone initiated with the above-mentioned polyhydric alcohols.

3) Polycarbonates containing hydroxyl groups such as the products obtained from reaction of the polyhydric alcohols previously set forth for preparing the polyhydroxy polyesters (preferably dihydric alcohols such as 1,3-propanediol, 1,4-butanediol, 1,4-dimethylol cyclohexane, 1,6-hexanediol, diethylene glycol, triethylene glycol or tetraethylene glycol) with phosgene, diaryl carbonates such as diphenyl carbonate or cyclic carbonates such as ethylene or propylene carbonate. Also suitable are polyester carbonates obtained by the reaction of lower molecular weight oligomers of the above-mentioned polyesters or polylactones with phosgene, diaryl carbonates or cyclic carbonates.

4) Polyethers include the polymers obtained by the reaction of starting compounds which contain reactive hydrogen atoms with alkylene oxides such as propylene oxide, butylene oxide, styrene oxide, tetrahydrofuran, epichlorohydrin or mixtures of these alkylene oxides. Certain proportions of ethylene oxide may also be included, provided the polyether does not contain more than 10% by weight of ethylene oxide; however, polyethers which do not contain ethylene oxide are preferably used. Suitable starting compounds containing at least one reactive hydrogen atom include the polyols set forth as suitable for preparing the polyhydroxy polyesters and, in addition, water, methanol, ethanol, 1,2,6-hexanetriol, 1,2,4-butanetriol, trimethylol ethane, pentaerythritol, mannitol, sorbitol, methyl glycoside, sucrose, phenol, isononyl phenol, resorcinol, hydroquinone and 1,1,1- or 1,1,2-tris(hydroxylphenyl)ethane. Polyethers which have been obtained by the reaction of starting compounds containing amino groups can also be used, but are less preferred for use in the present invention. Suitable amine starting compounds include ethylene diamine, diethylene triamine, triethylene tetraamine, 1,6-hexanediamine, piperazine, 2,5-dimethyl piperazine, 1-amino-3-aminomethyl-3,5,5-trimethylcyclohexane, bis(4-aminocyclohexyl)methane, bis(4-amino-3-methylcyclohexyl)methane, 1,4-cyclohexanediamine, 1,2-propanediamine, hydrazine, aminoacid hydrazides, hydrazides of semicarbazido carboxylic acids, bis-hydrazides and bis-semicarbazides, ammonia, methylamine, tetramethylenediamine, ethanolamine, diethanolamine, triethanolamine, aniline, phenylenediamine, 2,4- and 2,6-toluylenediamine, polyphenylene polymethylene polyamines of the kind obtained by the aniline/formaldehyde condensation reaction and mixtures thereof. Resinous materials such as phenol and cresol resins may also be used as the starting materials. The preferred starting compounds for the polyethers are those compounds which exclusively contain hydroxyl groups, while compounds containing tertiary amine groups are less preferred and compounds containing isocyanate-reactive-NH groups are much less preferred.

Polyethers modified by vinyl polymers are also suitable for the process according to the invention. Products of this kind may be obtained by polymerizing, e.g., styrene and acrylonitrile in the presence of polyethers (U.S. Pat. Nos. 3,383,351; 3,304,273; 3,523,095; and 3,110,695; and German Patent No. 1,152,536). Also suitable as polyethers are amino polyethers wherein at least a portion of the hydroxyl groups of the previously described polyethers are converted to amino groups.

5) Polythioethers such as the condensation products obtained from thiodiglycol on its own and/or with other glycols, dicarboxylic acids, formaldehyde, amino carboxylic acids or amino alcohols. The products are either polythio mixed ethers, polythio ether esters, or polythioether ester amides, depending on the co-components.

6) Polyacetals including those obtained from the above-mentioned polyhydric alcohols, especially diethylene glycol, triethylene glycol, 4,4′-dioxyethoxy-diphenyldimethylene, 1,6-hexanediol and formaldehyde. Polyacetals suitable for use in the invention may also be prepared by the polymerization of cyclic acetals.

7) Polyether esters containing isocyanate-reactive groups and known in the art.

8) Polyester amides and polyamides including the predominantly linear condensates obtained from polyvalent saturated and unsaturated carboxylic acids or their anhydrides and polyvalent saturated and unsaturated amino alcohols, diamines, polyamines, or mixtures thereof.

The preferred high molecular weight isocyanate-reactive compounds for use in the process according to the invention are the dihydroxy polyesters, dihydroxy polylactones, dihydroxy polycarbonates and dihydroxy polyester carbonates.

Suitable low molecular weight isocyanate-reactive compounds which may optionally be used in accordance with the present invention to prepare the hydroxy functional polyurethanes have molecular weights of up to about 400 and functionalities which correspond to those of the hydroxy functional polyurethanes. Examples include the polyols and diamines previously set forth for use in the preparation of the polyhydroxy polyesters and the polyethers and the aminoalcohols set forth hereinafter.

In order to make the hydroxy functional polyurethanes water dispersible, it is necessary to chemically incorporate hydrophilic groups, i.e., anionic groups, potential anionic groups or nonionic hydrophilic groups, into the polyisocyanate component. Suitable hydrophilic components contain at least one isocyanate-reactive group and at least one hydrophilic group or potential hydrophilic group. Examples of compounds which may be used to incorporate potential ionic groups include aliphatic hydroxy carboxylic acids, aliphatic or aromatic aminocarboxylic acids with primary or secondary amino groups, aliphatic hydroxy sulfonic acids and aliphatic or aromatic aminosulfonic acids with primary or secondary amino groups. These acids preferably have molecular weights below 400. It should be emphasized that the carboxylic acid groups are not considered to be isocyanate-reactive groups due to their sluggish reactivity with isocyanates.

The preferred anionic groups for incorporation into the hydroxy functional polyurethanes in the present invention are carboxylate groups and these groups may be introduced by using hydroxy-carboxylic acids of the general formula:

(HO)ₓQ(COOH)_{y}

wherein
Q represents a straight or branched, hydrocarbon radical containing 1 to 12 carbon atoms, and
x and y represent values from 1 to 3.

Examples of these hydroxy-carboxylic acids include citric acid and tartaric acid.

The preferred acids are those of the above-mentioned formula wherein x=2 and y=1. These dihydroxy alkanoic acids are described in U.S. Pat. No. 3,412,054, the contents of which are hereby incorporated by reference. The preferred group of dihydroxy alkanoic acids are the α,α-dimethylol alkanoic acids represented by the structural formula:

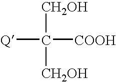

wherein Q′ is hydrogen or an alkyl group containing 1 to 8 carbon atoms. The most preferred compound is α,α-dimethylol propionic acid, i.e, wherein Q′ is methyl in the above formula.

The acid groups may be converted into hydrophilic anionic groups by treatment with a neutralizing agent such as an alkali metal salt, ammonia or a primary, secondary or preferably tertiary amine in an amount sufficient to render the hydroxy functional polyurethanes water dispersible. Suitable alkali metal salts include sodium hydroxide, potassium hydroxide, sodium hydride, potassium hydride, sodium carbonate, potassium carbonate, sodium bicarbonate and potassium bicarbonate. The use of alkali metal salts as neutralizing agents is less preferred than the use of volatile organic compounds such as volatile amines since they lead to reduced resistance to water swell in the coatings produced from the water dispersible compositions of the present invention. Therefore, less than 50%, preferably less than 20% and most preferably none of the acid groups should be neutralized with alkali metals.

The preferred volatile amines for neutralizing the acid groups are the tertiary amines, while ammonia and the primary and secondary amines are less preferred. Examples of suitable amines include trimethylamine, triethylamine, triisopropylamine, tributylamine, N,N-dimethyl-cyclohexylamine, N,N-dimethylstearylamine, N,N-dimethylaniline, N-methylmorpholine, N-ethylmorpholine, N-methylpiperazine, N-methylpyrrolidine, N-methylpiperidine, N,N-dimethylethanolamine, N,N-diethylethanolamine, triethanolamine, N-methyldiethanolamine, dimethylaminopropanol, 2-methoxyethyldimethylamine, N-hydroxyethylpiperazine, 2-(2-dimethylaminoethoxy)ethanol and 5-diethylamino-2-pentanone. The most preferred tertiary amines are those which do not contain isocyanate-reactive groups as determined by the Zerewitinoff test since they are capable of reacting with isocyanate groups during the curing of the compositions of the present invention.

In a preferred embodiment of the present invention volatile tertiary amines are used so when the water dispersible coating composition of the subject application is cured, the tertiary amine is removed from the coated substrate.

The acid groups may be converted into hydrophilic anionic groups by treatment with the alkali metal or preferably the volatile amine either before, during or after their incorporation into the hydroxy functional polyurethane. However, it is preferred to neutralize the acid groups after their incorporation.

The compounds containing lateral or terminal, hydrophilic ethylene oxide units have at least one, preferably one, isocyanate-reactive group and are an optional component, which may be present in an amount sufficient to provide a content of hydrophilic ethylene oxide units (calculated as —CH2-CH2-O—) present in lateral or terminal chains of up to 25% by weight. When compounds containing hydrophilic ethylene oxide units are used, they are preferably incorporated into the hydroxy functional polyurethanes in an amount sufficient to provide a content of hydrophilic ethylene oxide units of greater than 1% by weight, more preferably greater than 3% by weight, based on the weight of the hydroxy functional polyurethane. The preferred upper limit for the hydrophilic ethylene oxide units is 10% by weight, more preferably 7% by weight, based on the weight of the hydroxy functional polyurethane.

Hydrophilic components having terminal or lateral hydrophilic chains containing ethylene oxide units include compounds corresponding to the formulas:

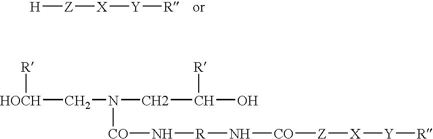

wherein R represents a difunctional radical obtained by removing the isocyanate groups from a diisocyanate corresponding to those previously set forth,

R′ represents hydrogen or a monovalent hydrocarbon radical containing from 1 to 8 carbon atoms, preferably hydrogen or a methyl group,

R″ represents a monovalent hydrocarbon radical having from 1 to 12 carbon atoms, preferably an unsubstituted alkyl radical having from 1 to 4 carbon atoms,

X represents the radical obtained by removing the terminal oxygen atom from a polyalkylene oxide chain having from 5 to 90 chain members, preferably 20 to 70 chain members, wherein at least 40%, preferably at least 65%, of the chain members comprise ethylene oxide units and the remainder comprises other alkylene oxide units such as propylene oxide, butylene oxide or styrene oxide units, preferably propylene oxide units,

Y represents oxygen or —NR′″— wherein R′″ has the same definition as R″ and

Z represents a radical which corresponds to Y, but may additionally represent —NH—.

The compounds corresponding to the above formulae may be produced by the methods according to U.S. Pat. Nos. 3,905,929, 3,920,598 and 4,190,566 (the disclosures of which are herein incorporated by reference). The monofunctional hydrophilic synthesis components are produced, for example, by alkoxylating a monofunctional compound such as n-butanol or N-methyl butylamine, using ethylene oxide and optionally another alkylene oxide, preferably propylene oxide. The resulting product may optionally be further modified (although this is less preferred) by reaction with ammonia to form the corresponding primary amino polyethers.

The hydroxy functional polyurethanes have a content of chemically incorporated anionic groups of 0 to 200, preferably 10 to 200, more preferably 10 to 180 and most preferably 20 to 100 milliequivalents per 100 g of solids, and a content of chemically incorporated nonionic groups of 0 to 25% by weight. When compounds containing hydrophilic ethylene oxide units are used, they are preferably incorporated into the hydroxy functional polyurethanes in an amount sufficient to provide a content of hydrophilic ethylene oxide units of greater than 1% by weight, more preferably greater than 3% by weight, based on the weight of the hydroxy functional polyurethane. The upper limit for the content of the hydrophilic ethylene oxide units is preferably 10% by weight, more preferably 7% by weight, based on the weight of the hydroxy functional polyurethane. The amounts of the anionic groups and hydrophilic ethylene oxide units must be sufficient for the hydroxy functional polyurethane to remain stably dispersed in water.

The hydroxy functional polyurethanes may be produced according to methods known in the art. For example, the above-mentioned reaction components may be added in any sequence. One preferred method comprises mixing all of the isocyanate-reactive components and subsequently reacting the mixture with the polyisocyanate. The number of isocyanate-reactive groups per isocyanate group is maintained at 1.1:1 to 4:1, preferably 1.2:1 to 1.8:1. The mixture is then reacted until no further NCO groups can be detected. The reaction may take place in the melt or in the presence of organic solvents. Suitable solvents include the water-miscible solvents normally used in polyurethane chemistry such as esters, ketones, halogenated hydrocarbons, alkanes and arenes. Low boiling solvents include those boiling at temperatures in the range of 40° to 90° C. such as acetone and methyl ethyl ketone. In addition, higher boiling solvents such as N-methyl pyrrolidone, dimethyl formamide, dimethyl sulfoxide, propylene glycol monomethyl ether acetate and ethylene glycol mono(-methyl, -ethyl or -butyl) ether acetate may be utilized.

In another preferred method, an NCO terminated prepolymer is prepared by reacting the polyisocyanate with the high molecular weight polyol, the isocyanate-reactive compound containing the hydrophilic or potential hydrophilic group and optionally a low molecular weight compound containing at least two isocyanate reactive groups. The NCO prepolymer is then converted to an hydroxy functional polyurethane by a further reaction with a primary or secondary monoamine containing at least one hydroxy group. Suitable examples of these monoamines include ethanolamine, N-methylethanolamine, diethanolamine, 3-amino-1-propanol and 2-amino-2-hydroxymethylpropane-1,3-diol.

In a further preferred method, an NCO terminated prepolymer is prepared as described above. However, instead of capping the isocyanate groups with a monoamine, the NCO terminated prepolymer is chain extended with a hydroxy group-containing polyamine, e.g, N-hydroxyethyl-ethylene diamine. When this chain extender is used in an amount which is sufficient to provide an NCO:NH ratio of approximately 1, a chain extended, hydroxy functional polyurethane is obtained which contains lateral hydroxy groups.

To prepare the aqueous coating compositions, the amount of the hydrophobic polyisocyanate component and the hydroxyl functional polyurethane reactive component are selected to provide equivalent ratios of isocyanate groups (whether present in blocked or unblocked form) to isocyanate-reactive groups of about 0.8 to 3, preferably about 0.9 to 1.5. The hydroxyl functional polyurethane is blended with several additives using a cowls blade. The hydrophobic polyisocyanate is then added and stirred. Deionized water may be added to adjust viscosity. The coating compositions may be cured either at ambient temperature or at elevated temperature.

To accelerate curing, the coating compositions may contain known polyurethane catalysts, e.g., tertiary amines such as triethylamine, pyridine, methyl pyridine, benzyl dimethylamine, N,N-dimethylamino cyclohexane, N-methyl-piperidine, pentamethyl diethylene triamine, 1,4-diazabicyclo[2,2,2]-octane and N,N′-dimethyl piperazine; or metal salts such as iron(III)-chloride, zinc chloride, zinc-2-ethyl caproate, tin(II)-ethyl caproate, dibutyltin(IV)-dilaurate and molybdenum glycolate.

The coating compositions may also contain other additives such as pigments, dyes, fillers, levelling agents and solvents. The coating compositions may be applied to the substrate to be coated in solution or from the melt by conventional methods such as painting, rolling, pouring or spraying.

The invention is further illustrated, but is not intended to be limited by the following examples in which all parts and percentages are by weight unless otherwise specified.

### EXAMPLES

In the examples, the allophanate group contents are based on the theoretical content assuming 100% conversion of the urethane groups to allophanate groups.

### Fluorinated Alcohol BA-LD

A fluorinated alcohol mixture having an equivalent weight of 416 (available from DuPont as Zonyl BA-LD) and corresponding to the general formula

F₃CCF₂ₙCH₂CH₂OH

wherein n is from 2-8.

### Polyisocyanate 3600

An isocyanurate group-containing polyisocyanate prepared from 1,6-hexamethylene diisocyanate and having an equivalent weight of 183, an isocyanate content of 22.8%, a content of monomeric diisocyanate of <0.25%, a viscosity at 25° C. of 1145 mPa·s and a surface tension of 45 dynes/cm (available from Bayer Material Science as Desmodur N 3600).

### PNPAD

Polyneopentylene adipate diol, equivalent weight 1000 g/mole, available from Witco Inc. as Foamrez 55-56

### PEO Stabilizer

Polyether monool prepared from butylcarbitol and mixture of PO and EO units, OH number 25 mg KOH/g, 2280 average equivalent weight

### H12MDI

Desmodur W bis-4-isocyanatocyclohexyl methane, available from Bayer Material Science, average equivalent weight 131.2

### IPDI

Desmodur I isophorone diisocyanate, available from Bayer MaterialScience, average equivalent weight 111.1

### DMPA

2,2-Dimethylol propanoic acid, equivalent weight 67.1

### BEPD

2-Butyl-2-ethyl-1,3-propanediol, equivalent weight 80.1

### TEA

Triethyl amine, equivalent weight 101.2

### NMP

1-Methyl-2-pyrrolidinone solvent

### DEOA

Diethanol amine, equivalent weight 105.1

### Byk 346

Flow additive, BYK-Chemie USA

### Byk 028

Flow additive, BYK-Chemie USA

### Tinuvin 5151

Light stabilizer, Ciba Specialty Chemicals

### Surface Tension of Liquid Samples

The Wilhelmy plate technique (flamed glass slides) was used to determine surface tension. The sample was stirred prior to analysis and analyzed with a Cahn DCA 312 dynamic contact angle analyzer. Standard deviation was 2 dynes/cm.

### Surface Energy of Film Samples

Advancing angles of water and methylene iodide, polar and non-polar solvents respectively, were measured using a Rame-Hart goniometer. Total solid surface energy, including the polar and dispersive components, was calculated using the advancing angles according to the Owens Wendt procedure. Based on the range of contact angles of the two different probe liquids, the standard deviation was estimated to be 2 dynes/cm.

### EXAMPLE 1

### Preparation of Hydroxy-Functional Polyurethane Dispersion

215.4 g (0.214 eq) PNPAD, 33.3 g (0.415 eq) BDPD, 33.5 g (0.500 eq) DMPA, and 8.87 g (0.004 eq) PEO stabilizer were added to a 1000 ml, 3-neck, round flask fitted with agitator, additional funnel, nitrogen inlet, thermocouple and condenser. The mixture was heated to 90° C. and stirred. After the DMPA dissolved, 131.2 g (1.367 eq) H12MDI and 50.6 g (0.456 eq) IPDI was added to the mixture. The reaction was allowed to proceed at 90° C. for 3 hours until the % NCO of the prepolymer solution reached the theoretical NCO content of 4.36%. The reaction was then cooled to 50° C. 25.3 g (0.250 eq) TEA and 8.87 g (0.004 eq) PEO stabilizer were mixed with 22.5 g NMP and added to the prepolymer solution immediately after the NCO measurement. The prepolymer mixture was mixed for five minutes.

The dispersion was then prepared by the addition of the prepolymer under high shear to 79.3 g of room temperature, distilled water that had previously been charged into a dispersing flask over a thirty minute period. After ten minutes of stirring under high shear, chain extension/termination was accomplished by the addition of 71.9 g (0.684 eq) DEOA into the dispersion over a ten minute period. The dispersion was post reacted for an additional one hour under high shear and then filtered through 75 μm filter. The dispersion characteristics were determined after the finished dispersion had aged one week:

Non-volatile content, 40%

Water content, 50%

NMP content, 10%

Viscosity @25° C., 2200 mPa·sec

Equivalent weight, as supplied, 1100 g/mole

Density @25° C., 8.8 lbs/gal (1.06 g/ml)

### EXAMPLE 2

### Preparation of Hydrophobic Polyisocyanate

1080 g (5.90 eq) of Polyisocyanate 3600 and 120 g (0.29 eq) of Fluorinated Alcohol BA-LD were charged to a 2000 mL, 3-neck round bottom flask equipped with mechanical stirring, a cold water condenser, heating mantle, and N₂ inlet. The reaction mixture was heated to 90° C. After 1 hour at 90° C., 0.30 g of stannous octoate were charged to the mixture and the temperature was increased to 110° C. After cooking for 12 hours at 110° C., the NCO reached 18.57% NCO (theoretical, 18.64%). The heat was removed and a cold water/ice bath was applied. The viscosity was 4180 cps @25° C. The surface tension of the liquid was 22 dynes per cm.

### EXAMPLE 3

80.34 g of the hydroxy-functional polyurethane dispersion prepared in Example 1 was blended with 0.49 g Byk 346, 0.50 g Byk 028 and 0.50 g Tinuvin 5151. To this mixture was added 18.17 g of the hydrophobic polyisocyanate prepared in Example 2. This mixture was stirred with a cowels bade at 1500 rpm for 5 minutes. Finally, 12.00 g deionized water was added to the correct consistency to make a film. The film was prepared by draw down method, air flashed at room temperature for 5 minutes and baked at 94 C for 45 minutes.

### EXAMPLE 4 (COMPARATIVE)

A formulation was prepared according to the process of Example 3, except Polyisocyanate 3600 was used instead of the hydrophobic polyisocyanate of Example 2.

### Stain Test

### Black Marker

A sharpie brand black marker was used to deface the cured films. The ink was allowed to dry for 2 minutes at room temperature. Isopropanol was then applied to remove the mark. The film of Example 3 was clean with no residual stain. The film of Example 4 left a black shadow where the ink had been applied.

### Mustard

Although the above test was done to test for graffiti resistance, Heinz brand yellow mustard was applied to the cured films as a more severe test. The soiled films were tested covered and uncovered at room temperature for one hour. The films were wiped with a towel and cleaned with water. The film using the hydrophobic polyisocyanate was clean with no residual stain.

This data shows that coatings made from aqueous two-component coating compositions containing fluorine-modified polyisocyanate mixtures, had increased stain resistance compared with unmodified polyisocyanates. Further, it was surprising that the mixture of a hydrophobic polyisocyanate and an aqueous polyurethane dispersion formed a stable dispersion, given the hydrophobic nature of the polyisocyanate mixture.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An aqueous coating composition comprising the reaction product of
A) a hydrophobic polyisocyanate mixture
i) having an NCO content of 5 to 35% by weight and a monomeric diisocyanate content of less than 3% by weight, and prepared from a polyisocyanate adduct,
ii) containing allophanate groups in an amount such that there are more equivalents of allophanate groups than urethane groups and
iii) containing fluorine (calculated as F, AW 19) in an amount of 0.001 to 50% by weight,
wherein the preceding percentages are based on the solids content of the polyisocyanate mixture and wherein fluorine is incorporated by reacting an isocyanate group with a compound containing two or more carbon atoms, one or more hydroxyl groups and one or more fluorine atoms, and
B) an aqueous, hydroxyl functional polyurethane dispersion.

2. The aqueous coating composition of claim 1, wherein the aqueous, hydroxyl-functional polyurethane dispersion has
a) an average hydroxy functionality of at least 1.8,
b) a total content of urethane and urea groups, calculated as —NH—CO—, of 9 to 20% by weight, based on the weight of the polyurethane,
c) 0 to 200 milliequivalents of chemically incorporated anionic groups per 100 g of polyurethane and
d) 0 to 25% by weight, based on the weight of the polyurethane, of ethylene oxide units incorporated within terminal and/or lateral polyether chains,
wherein c) and d) are present in an amount which is sufficient to maintain the polyurethane stably dispersed in water.

3. The aqueous coating composition of claim 1 wherein fluorine is incorporated by reacting an isocyanate group with a compound containing two or more carbon atoms, one hydroxyl group and one or more fluorine atoms.

4. The aqueous coating composition of claim 3, wherein said fluorine is incorporated by reacting an isocyanate group with a compound of the formula:
F₃CCF₂ₙCH₂CH₂OH
wherein n is from 2-8.

5. The aqueous coating composition of claim 1 wherein said polyisocyanate adduct comprises an isocyanurate group-containing polyisocyanate prepared from 1,6-hexamethylene diisocyanate or isophorone diisocyanate.

6. The aqueous coating composition of claim 2 wherein said polyisocyanate adduct comprises an isocyanurate group-containing polyisocyanate prepared from 1,6-hexamethylene diisocyanate or isophorone diisocyanate.

7. The aqueous coating composition of claim 4 wherein said polyisocyanate adduct comprises an isocyanurate group-containing polyisocyanate prepared from 1,6-hexamethylene diisocyanate or isophorone diisocyanate.

8. The aqueous coating composition of claim 1 wherein the polyisocyanate mixture contains 0.1 to 10% by weight, based on solids, of fluorine.

9. The aqueous coating composition of claim 2 wherein the polyisocyanate mixture contains 0.1 to 10% by weight, based on solids, of fluorine.

10. The aqueous coating composition of claim 3 wherein the polyisocyanate mixture contains 0.1 to 10% by weight, based on solids, of fluorine.

11. The aqueous coating composition of claim 4 wherein the polyisocyanate mixture contains 0.1 to 10% by weight, based on solids, of fluorine.

12. The aqueous coating composition of claim 7 wherein the polyisocyanate mixture contains 0.1 to 10% by weight, based on solids, of fluorine.

13. The aqueous coating composition of claim 1 wherein the polyisocyanate mixture contains 10 to 40% by weight, based on solids, of fluorine.

14. The aqueous coating composition of claim 2 wherein the polyisocyanate mixture contains 10 to 40% by weight, based on solids, of fluorine.

15. The aqueous coating composition of claim 3 wherein the polyisocyanate mixture contains 10 to 40% by weight, based on solids, of fluorine.

16. The aqueous coating composition of claim 4 wherein the polyisocyanate mixture contains 10 to 40% by weight, based on solids, of fluorine.

17. A process for the production of an aqueous coating composition comprising
1) preparing a hydrophobic polyisocyanate mixture:
i) having an NCO content of 5 to 35% by weight and a monomeric diisocyanate content of less than 3% by weight, and prepared from a polyisocyanate adduct,
ii) containing allophanate groups in an amount such that there are more equivalents of allophanate groups than urethane groups and
iii) containing fluorine (calculated as F, AW 19) in an amount of 0.001 to 50% by weight,
wherein the preceding percentages are based on the solids content of the polyisocyanate mixture, by
a) reacting a portion of the isocyanate groups of a polyisocyanate adduct with 0.01 to 500 millimoles, per mole of polyisocyanate adduct, of a compound containing two or more carbon atoms, one or more hydroxyl groups and one or more fluorine atoms to form urethane groups,
b) adding an allophanatization catalyst prior to, during or after step a),
c) converting a sufficient amount of the urethane groups formed in step a) to allophanate groups to satisfy the requirements of ii) and
d) terminating the allophanatization reaction at the desired NCO content by adding a catalyst poison and/or by thermally deactivating the catalyst and recovering the polyisocyanate mixture without removing monomeric diisocyanates,
2) before, during or after step 1), preparing an aqueous, hydroxyl functional polyurethane dispersion, and
3) combining the hydrophobic polyisocyanate mixture with the aqueous, hydroxyl functional polyurethane dispersion.
